(19) United States
(12) Patent Application Publication
(10) Pub. No.: US 2016/0014405 A1
(43) Pub. Date: Jan. 14, 2016

(54) METHOD AND APPARATUS FOR CALIBRATING A CAMERA

(71) Applicant: Apple Inc., Cupertino, CA (US)

(72) Inventors: Thomas B. Beckman, Santa Clara, CA (US); Jonathan L. Berk, Mountain View, CA (US)

(21) Appl. No.: 14/337,166

(22) Filed: Jul. 21, 2014

Related U.S. Application Data
(60) Provisional application No. 62/022,622, filed on Jul. 9, 2014.

(51) Int. Cl. H04N 17/00; H04N 5/225

(52) U.S. Cl. CPC H04N 17/002; H04N 5/2254

(57) ABSTRACT

An apparatus for capturing a test image that can be used in calibrating a camera. In some embodiments, the apparatus reflects light toward the lens of a camera such that a central target subject is captured at the center while a reflection of that same target subject is reflected to each corner of the test image. The apparatus includes an adapter for holding a set of mirrors in the field of view of the camera, each mirror reflecting a target at the center of the field of view. The apparatus of some embodiments is configurable to change the angle of the mirrors based on a focal length of the lens of the camera.

### CLAIM OF BENEFIT TO PRIOR APPLICATION

This application claims the benefit of U.S. Provisional Application 62/022,622, filed Jul. 9, 2014. U.S. Application 62/022,622 is incorporated herein by reference.

### BACKGROUND

Cameras are used for capturing images for various purposes in many different industries. Cameras include a lens, either as a fixed part of the camera or as a separate attachable element. Cameras will also include a sensor or other medium (such as film) for recording an image. Lenses of the cameras are often composed of multiple lens elements. A lens captures light from a scene and bends the light using several lens elements to expose a capturing medium, such as film or a digital sensor. In a digital camera, the capturing medium is an image sensor that captures the light on pixels of the image sensor and translates it into a digital picture.

There are many different types of lenses with various characteristics. Different lenses will differ in the number and type of lens elements used to bend the light for the image sensor. For example, lenses with different focal lengths will capture different fields of view. For longer focal lengths (e.g., standard or telephoto lenses), the field of view is smaller. For example, when a camera is zoomed in, the focal length is at its longest and an image captured at this point will reflect a small portion of a scene. On the other hand, for shorter focal lengths (e.g., wide-angle lenses), the captured image will reflect a much larger portion of the scene.

Design choices and imperfections of the lens of a camera will also affect the image captured on the camera sensor. Even for a particular lens or camera, different regions of the captured image will have different properties.

FIG. 1 illustrates an example of different regions of an image. The left side of this figure illustrates an image sensor 105 and a projected circle 110. The right side of the figure illustrates an example image 120 captured by the image sensor 105.

The image sensor 105 is a medium in a camera (e.g., film, CCD sensor, CMOS sensor, etc.) for capturing the image 120. The projected circle 110 illustrates the area of light projected through a lens onto the capture plane. However, only the portion of the projected circle 110 that is projected on to the image sensor 105 becomes a part of the image 120. The radius 115 of the image sensor 105 corresponds to the diagonal 130 of image 120.

Image quality at different regions of the image sensor 105 may vary due to lens design, and imperfections in the lens or the image sensor 105. In many cases, the camera and/or lens are optimized to provide the best image at the center 125 of the capture plane 105 and quality may degrade further away from the center of the image sensor.

As illustrated, the corners of the image are the furthest away from the center of the image sensor 105. The radius 115 shows that the corners of the image will capture the light farthest away from the center of the lens. Accordingly, the corners of the image will often see the greatest degradation in image quality. For example, objects captured in the image move in and out of focus based on how light from the object is captured through the lens. Focusing on a subject changes the way that the light is bent such that all of the light from a point on the subject will reach a single point on the camera sensor. The more diffracted the light is, the blurrier the image becomes. However, the precision of a lens may drop off further away from the center of the lens elements, introducing imperfections and errors. When light is diffracted, a target that should be in focus may appear slightly soft, or out of focus.

As such, it is desirable to test the sharpness of a camera (and/or lens), not only at the center of the image, but at the edges as well. At short distances, it is easy to set up a testing chart that fully covers the area of the camera sensor. A testing chart provides various tests for resolution and sharpness that allow a user to determine the sharpness of the camera. However, when focusing at longer distances, the size of a testing chart necessary to encompass the entire sensor area is no longer feasible. For example, at a distance of only 300 feet, a wide angle lens could require a target 600 feet wide and 600 feet high. Therefore, testing a camera in long distance photography presents its own challenges. FIG. 2 illustrates an example of such challenges.

FIG. 2 illustrates a test image 202 taken at a long front focal distance. The left side of the figure illustrates a top-down view 201 of the camera 220, along with view lines 205 and 210 for capturing a target subject 225. The top-down view 201 shows a tree 230 and a building 235.

The right side of the figure illustrates a test image 202 that includes a center region 211 and four corner regions 212-215. In this example, imagine that the camera is rotated such that the corners of the field of view are at the left and right. In the test image 202 on the right side of the image, the center target subject 225 is shown in the center region 211. The center target image is 2000 feet away. The test image 202 also shows the obstructing tree 230 in the bottom left corner, the building 235 in the bottom right corner, and open sky in the top regions 212 and 213.

Test image 202 presents various problems for use as a test image for calibrating a camera (or its lens). For example, while the lens of the camera is focused on the center target 2000 feet away, the obstructing tree 230 in the bottom left corner 215 is only 100 feet away. The tree 230 may appear unfocused in the test image 202 because it is too close to the lens to remain in focus with the center target and not necessarily because of some imperfection in the lens or camera. Similarly, the building 235 in the bottom right corner 214 is 500 feet away, and it would be difficult to determine whether a lack in sharpness is a result of the lens or the distance to the building 235. Finally, the top corners present yet another problem. The sky lacks enough detail to determine whether that part of the image is in focus or not.

In order to work around these difficulties, some people go to a high elevation and take test images by shooting down towards the earth. With enough elevation, such a test image may provide a reasonable test of long distance focusing of a camera setup. However, getting to such a high elevation is often difficult and not suited for camera calibrations. Other methods involve taking multiple photographs of a single target, rotating and moving the camera in order to test different regions of the photograph. However, using multiple photographs is time consuming as the camera has to be moved to different angles and positions to capture the target and introduces additional errors.

### BRIEF SUMMARY

In order to generate a test image for testing characteristics (e.g., sharpness, contrast, back-focus, etc.) of a camera, some embodiments provide an apparatus that reflects a single target to different regions of the test image. Reflecting a single target to the different regions of the test image simplifies comparisons of the different regions of the test image when analyzing the different characteristics of the camera. To calibrate a camera/lens and test the different regions of the image captured with a particular lens, the apparatus of some embodiments causes each region of the test image to be in focus and have a meaningful level of detail. In this application, references will be made to calibrating cameras, lenses, and/or sensors. It should be understood that calibrating any one of cameras, lenses or sensors may include calibrating any combination of them.

When a particular region of the image is too close or too far to be in focus in the test image, then it becomes difficult to determine whether the lack of sharpness in the particular region is due to a lack of focus or imperfections in the lens. Also, when a particular region of the image lacks a meaningful level of detail (e.g., a clear blue sky), then different characteristics of the particular region (e.g., sharpness, contrast, etc.) cannot be determined.

In some embodiments, the apparatus is set up on a lens of a camera and includes a set of mirrors for reflecting light toward the lens of the camera. The mirrors are placed such that a central target subject is at the center of a test image captured by the camera while a reflection of the same target subject is reflected to the edges of the test image. By placing the mirrors so that the center, focused area of the field of view is captured in the mirrors, the apparatus ensures that the distance to the targeted subject is the same for the center region as well as each edge region of the image. In addition, a user can ensure that each edge region has a sufficient level of detail to measure the different desired characteristics merely by ensuring that the center region has the sufficient level of detail. Using the same center portion of the image in each of the edge regions further simplifies the process because each region of the image will have the same content.

The mirrors of some embodiments are first surface mirrors. Many of the commonly available mirrors, such as bathroom mirrors, are second surface mirrors. Second surface mirrors have a transparent layer (such as glass) between the reflective surface and the light to be reflected. The transparent layer diffracts light, which may result in secondary reflections and ghosting when used at various angles. The reflective surface of first surface mirrors are exposed and do not have anything between the reflective surface and the reflected light. First surface mirrors allow light to be reflected directly from the surface without interference.

The apparatus of some embodiments includes an adapter that is configured to hold a set of mirrors in position such that the central target subject is shown at the edges of the captured test image. In some embodiments, the apparatus further includes an adjuster, either as a part of the adapter or separate from the adapter. The adjuster adjusts the positioning of the mirrors in order to capture the central target subject in the mirrors. When there are multiple mirrors, the adjuster of some embodiments adjusts the positioning of all of the mirrors simultaneously. In some embodiments, the adjuster automatically adjusts the mirrors based on a focal length set for the camera.

The advantage of this system is that a lens can be evaluated by evaluating the center and different regions (e.g., four corners) of a single test image while being focused to large distances, eliminating errors that are introduced by repositioning the camera to take individual images of each region separately. The captured test image can be analyzed to identify the quality of different regions of the sensor using a single image with a single target in multiple areas of the test image.

In some embodiments, the different regions of the test image are evaluated using an algorithm for identifying or scoring various characteristics (e.g., sharpness, contrast, etc.). In some embodiments, the test images are used to calibrate different settings (e.g., sensor backspacing, focusing distance, etc.) on the camera. For example, in some embodiments, test images are captured for several different focus settings and the different regions of the test images are evaluated to determine the particular focus settings that provide the sharpest overall image, rather than merely at the center of the image.

In some embodiments, a test image can also be used to identify problems in a camera/lens setup by comparing different regions of the test image. For example, when there are differences in sharpness between different corners of a test image, a user can determine that the alignment between the lens of the camera and the capture medium (e.g., film, digital sensors, etc.) needs to be adjusted.

In some embodiments, when capturing multiple images of a large scene (e.g., aerial views of a city), it can be desirable to minimize the redundancy of captured data. In order to minimize overlap between different images, the edges of the images become more important as a larger portion of each image is used in the final product. In some embodiments, in order to maximize the quality of the captured images from edge to edge, a series of test images is captured with the apparatus using several different settings on the camera. The different regions (i.e., edges, center, etc.) of each image are evaluated for a set of properties. The image with the best overall qualities is identified and the camera is set to use the corresponding settings.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an example of testing for sharpness in different regions of an image.

FIG. 2 illustrates an example of a test image taken at a long focal length.

FIG. 3 illustrates an apparatus for taking test images with a camera.

FIG. 4 illustrates an example of placement for the mirrors in the apparatus.

FIG. 5 illustrates an example of a test image taken at a long focal length.

FIG. 6 conceptually illustrates a process for calibrating settings on a camera using a series of test images.

FIG. 7 illustrates calibrating a focusing distance for cameras based on sharpness in the different regions of a test image.

FIG. 8 illustrates a computer system with which some embodiments described herein are implemented.

### DETAILED DESCRIPTION

In the following detailed description of the invention, numerous details, examples, and embodiments of the invention are set forth and described. However, it will be clear and apparent to one skilled in the art that the invention may be practiced without some of the specific details and examples discussed.

### I. Mirror Holder Apparatus

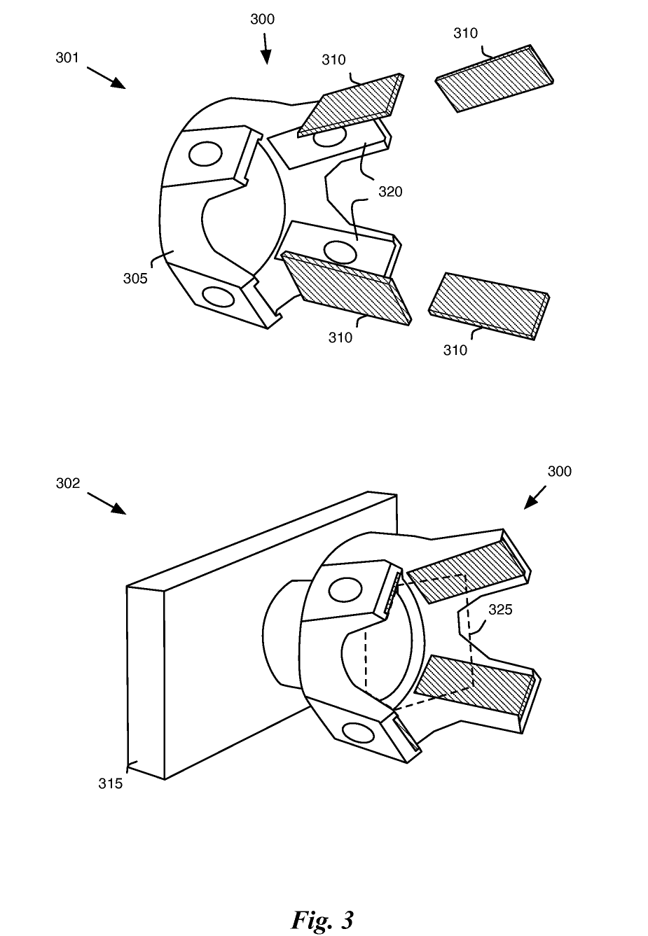

In order to generate a test image for testing characteristics (e.g., sharpness, contrast, back-focus, etc.) of a camera, some embodiments of the invention provide an apparatus that reflects a single target to different regions of a test image. Reflecting a single target to the different regions of the test image simplifies comparisons of the different regions of the test image when analyzing the different characteristics of the camera. FIG. 3 illustrates an apparatus 300 for taking test images with a camera. The first view 301 illustrates a disassembled view of the apparatus 300. The apparatus includes an adapter 305 and a set of mirrors 310.

The adapter 305 of some embodiments is configured to fit securely around the body of a camera lens. The adapter 305 holds the mirrors at a particular angle in the field of view of the camera in order to reflect the center portion of the field of view in the mirrors at each of the corners of the field of view. The mirrors are angled so that light from the center portion of the field of view enters the lens at the same angle as the light that is occluded by the mirrors, such that the mirrors 310 reflect the center portion of the field of view in the corners of the test image. In some embodiments, the adapter 305 includes grooves 320 to hold the mirrors 310 at the particular angle.

In some embodiments, the apparatus 300 further includes an adjuster (not shown), either as a part of, or separate from, the adapter 305. The adjuster adjusts the positioning of the mirrors 310 in order to capture the center portion of the field of view in the mirrors 310. When there are multiple mirrors, the adjuster of some embodiments adjusts the positioning of all of the mirrors simultaneously. In some embodiments, the adjuster automatically adjusts the mirrors 310 based on a focal length of the lens on the camera.

The set of mirrors 310 of some embodiments are first surface mirrors. Many of the commonly available mirrors, such as bathroom mirrors, are second surface mirrors. Second surface mirrors have a transparent layer (such as glass) between the reflective surface and the light to be reflected. The transparent layer diffracts light, which may result in secondary reflections and ghosting when used at various angles. First surface mirrors do not have this transparent layer, but rather directly expose the reflective surface to the light. First surface mirrors allow light to be reflected directly from the surface without diffraction and other interference.

The second view 302 illustrates that the apparatus 300 has been assembled by fitting and positioning the mirrors into the grooves 320. In addition, the assembled apparatus 300 has been fitted onto the lens of a camera 315. The second view 302 also shows the field of view 325 of the camera 315. The field of view 325 of the camera illustrates a plane, or a window, of everything that is “seen” or captured by the image sensor of the camera. Light captured by the image sensor of the camera through the field of view 325, is processed by the image sensor to generate the final image.

The field of view for a particular lens and camera depends on both a focal length of the lens and the image sensor of the camera. For longer focal lengths (e.g., standard or telephoto lenses), the field of view is reduced, capturing only a small portion of the scene in front of the camera. On the other hand, for shorter focal lengths (e.g., wide-angle lenses), the captured image will reflect a much larger area. For example, an image captured at long focal lengths (i.e., when a camera is zoomed in) may only capture the face of a person standing in a scene, while an image captured at shorter focal lengths from the same position may include the person as well as trees and buildings surrounding the person.

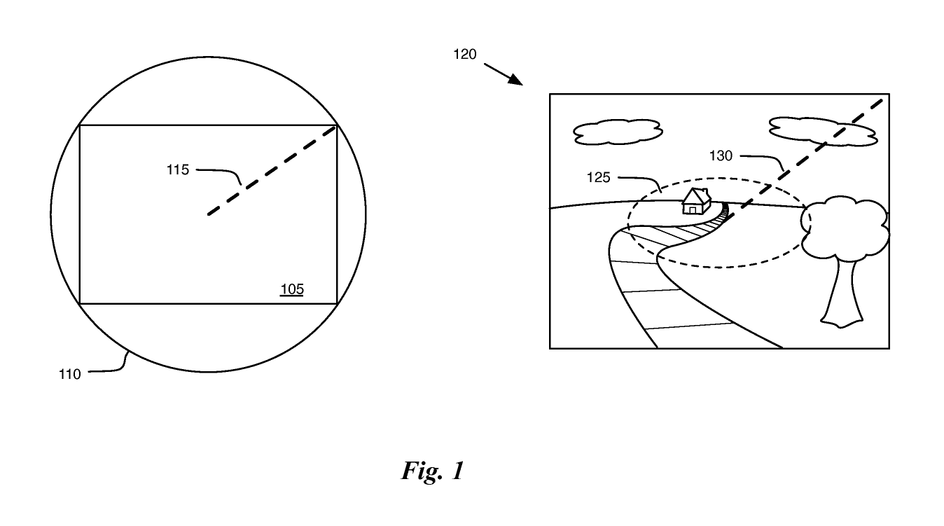

The shape of the field of view also depends on the shape of the image sensor. As described with reference to FIG. 1, even though the area of light projected by the lens is circular, only the portion that is captured by the image sensor will become a part of the final image. Because the image sensor is a rectangle, the field of view is usually also rectangular (unless the projected light of the lens does not encompass the entire image sensor (e.g., in fisheye lenses)). However, as the second view 302 further illustrates, the corners of the field of view 325 are now cut short by the mirrors 310. When a photograph is taken with the camera, rather than showing content from the corners of the field of view, the corners of the captured image will reflect whatever is shown in the mirrors 310. In order for the test image to provide useful test image data, the mirrors must be placed correctly.

To properly calibrate a camera/lens and test the different regions of the image captured with a particular lens, each region of the test image should be in focus and have a meaningful level of detail. When a particular region of the image is too close or too far to be in focus in the test image, then it becomes difficult to determine whether the lack of sharpness in the particular region is due to a lack of focus or imperfections in the lens. Also, when a particular region of the image lacks a meaningful level of detail (e.g., a clear blue sky), then different characteristics of the particular region (e.g., sharpness, contrast, etc.) cannot be determined.

By placing the mirrors so that the center, focused area of the field of view is captured in the mirrors, the apparatus ensures that the distance to the targeted subject is the same for the center region as well as each edge region of the image. In addition, a user can ensure that each edge region has a sufficient level of detail to measure the different desired characteristics merely by ensuring that the center region has the sufficient level of detail. Using the same center portion of the image in each of the edge regions further simplifies the process because each region of the image will have the same content.

Light from the center will be reflected at a same angle as the area of the field of view that is now occluded by the mirrors. In order to correctly test the camera/lens, in addition to ensuring that the subject of each region is an appropriate distance away and has a sufficient level of detail, it is necessary to direct the light from the target to the lens at the same angle as the light that would have entered the lens without the mirrors. The way that light is bent through the various elements of the lens depends on the angle at which the light enters the lens.

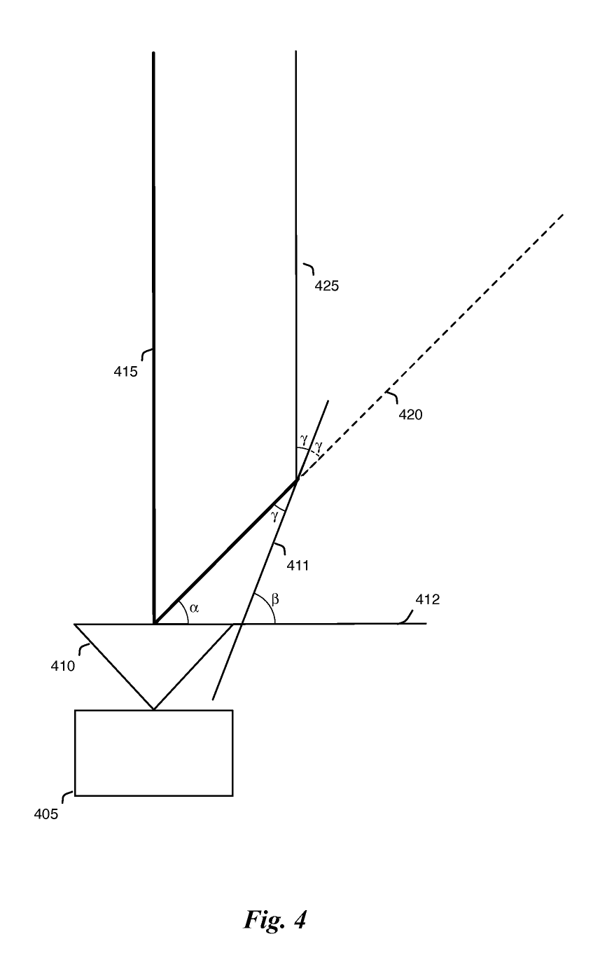

FIG. 4 illustrates an example of placement for the mirrors in the apparatus. This figure includes a camera 405, lens 410, and mirrors 411. The figure also illustrates a capture plane 412, the center axis 415 and the view line 420. The capture plane 412 represents the orientation of the image sensor in the camera. The center axis 415 is an imaginary axis running from the center of the camera 405, along the body of the lens, to the center of the field of view. The view line 420 represents a line running from the center of the camera 405 to an edge of the field of view.

In some embodiments, the angles for the mirrors 411 are calculated based on an angle of view of the lens/camera setup. The angle of view is the angle from the center axis 415 of the camera to view line 420. The angle of view is determined by the focal length of the lens and the image format. As the angle of view widens, the field of view expands. The angles for the mirrors are calculated such that the center of each mirror 411 reflects the center of the center region of the field of view.

Light reflects off of mirrors 411 at the same angle as the angle at which the light approaches the mirrors 411. The mirrors 411 are placed along the view line 420 in order to replicate the angles of the light that would have been captured at the edges of the field of view.

In some embodiments, the angle beta is calculated for placing the mirrors. The angle beta represents the angle between the capture plane 412 and the mirror 411 and is calculated based on the angles alpha and gamma. The complement alpha of the viewing angle measures the angle between the edge of the field of view 420 and the capture plane 412. The angle of view can be calculated based on the lens and the size of the sensor. The angle gamma represents the angle at which a line parallel to the center axis intersects (and is reflected from) the mirror 411. The angle beta is calculated based on a line 425 parallel to the center axis at the intersection between the edge of the field of view 420 and the mirror 411. Light will reflect off of mirror 411 at the same angle gamma as the angle gamma at entrance. With geometry, the angle between the mirror 411 and the field of view 420 is also gamma. The angle between the line 425 and the field of view 420 is the same as the angle between the center axis 415 and the field of view 420. The line 425 is used to simplify the calculation.

Since alpha is the complement of the angle of view and the angle of view is the same as the angle between the line 425 and the field of view 420, the desired angle between the line 425 and the mirror is half of the angle of view, or gamma. The desired angle could be 90+½ of angle of view. Or coming from the other side it could be the complement of the angle of view divided by 2 plus 45.

Alternatively, the angle beta in some embodiments could be calculated as:

$$α + 2 \cdot γ = 90 °$$

$$α + γ + 180 ° - β = 180 °$$

$$α + γ = β$$

$$γ = \frac{90 ° - α}{2}$$

$$β = α + γ$$

$$β = α + \frac{90 ° - α}{2}$$

$$β = α + \frac{90 ° - α}{2}$$

$$β = α - \frac{α}{2} + \frac{90 °}{2}$$

$$β = \frac{α}{2} + 45 °$$

In other embodiments, the angle of the mirror is manually adjusted on the apparatus until the center of the image is reflected in the mirror. Once the angles of the mirrors have been properly set, the camera can take a test image with the different regions of the image focused at the same distance.

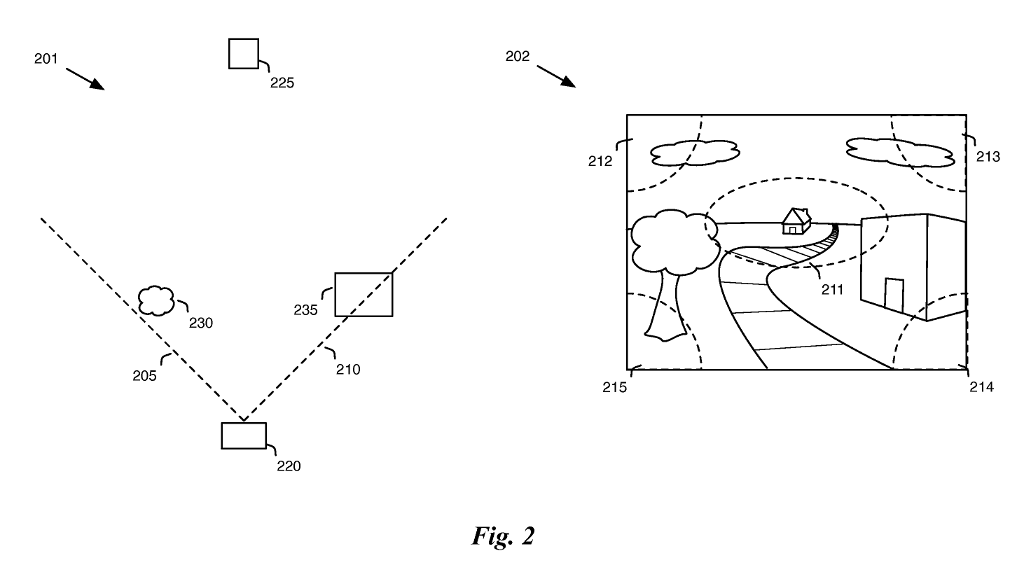

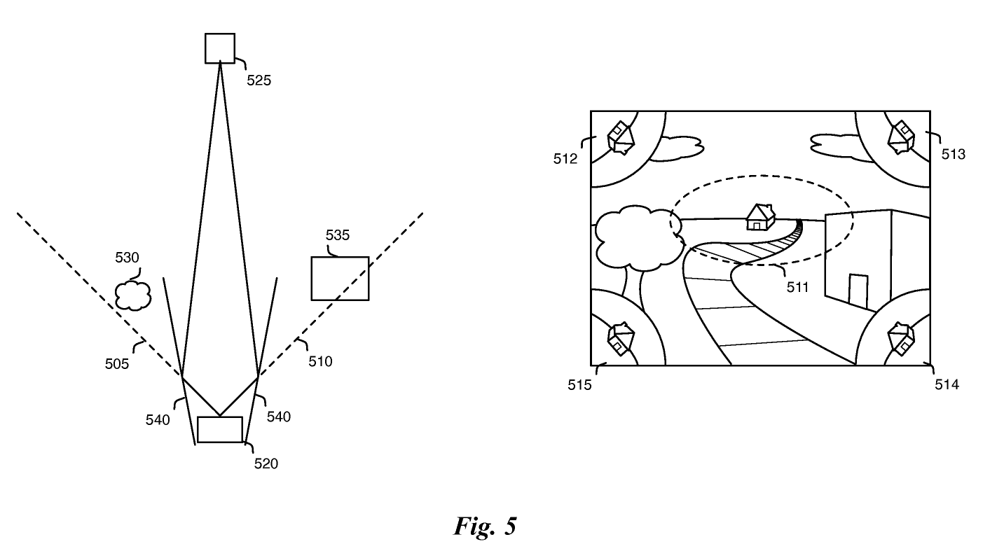

FIG. 5 illustrates an example of a test image produced by a camera using the apparatus of FIG. 3. The left and right sides of the figure are similar to the top-down view 201 and test image 202 of FIG. 2. Like the top-down view 201, top-down view 501 illustrates a top-down view of a camera 520, center target 525, tree 530 and building 535. In addition, the top-down view 501 also shows mirrors 540. In some embodiments, the mirrors 540 are held in place using the mirror-holding apparatus described above. The mirrors 540 are placed to block the corners of the test image 502 and to reflect the center target 525 in the mirrors 540.

Like test image 202 of FIG. 2, test image 502 shows a test image captured by camera 520 using the mirrors 540 of the apparatus. However, unlike test image 202, rather than displaying the sky, building 530, and tree 535 in the different corner regions 512-515, the center target 525 (region 511 of the image) is shown in each of the corner regions 512-515. The target reflected in the corner regions 512-515 is roughly the same distance from the camera as the center region, allowing for each region to maintain focus. The image is focused on the center portion of the image and each corner region reflects the same center target.

In some embodiments, rather than capturing a single target in the center portion of the test image, the camera captures multiple targets at various distances in the center portion that can then be evaluated to test properties of the test image (e.g., sharpness) at multiple distances. For example, in some embodiments, in addition to capturing a building at a first distance, the test image may also capture a horizon or another structure at a second, different distance. The multiple targets at the different distances are then captured in the center portion and reflected to the corners of the test image.

### II. Applications of the Test Image

Once the test image is captured with the apparatus, the test image can be used to test cameras/lenses by determining the properties of different cameras/lenses at long distances, to calibrate cameras for particular functions, and to detect potential problems in a camera and/or lens (i.e., sensor backspacing, sensor alignment, etc.).

In order to maintain similar sharpness/quality in images that are captured by different cameras, it is desirable to configure each camera and lens similarly. In some cases, it is desirable to optimize settings for a series of cameras in order to perform a particular function. However, even if the same model of cameras and lenses are used with the same set of settings, the setups may perform differently due to imperfections or incorrect settings in the setup. For example, multiple cameras may be used for capturing aerial images for mapping, etc.

In addition, sharpness across the entire image can be more important than sharpness at a particular point (i.e., the center) because the captured images may be stitched together to present a single image to the user. It may even be desirable to minimize the differences in sharpness for different regions of the image, even at the cost of overall sharpness for the image.

When capturing multiple images of a large scene (e.g., aerial views of a landscape), it can be desirable to minimize the redundancy of captured data. In order to minimize overlap between different images, the edges of the images become more important as a larger portion of each image is used in the final product. In some embodiments, in order to maximize the quality of the captured images from edge to edge, a series of test images is captured with the apparatus using several different settings on the camera. The different regions (i.e., edges, center, etc.) of each image are evaluated for a set of properties. The image with the best overall qualities is identified and the camera is set to use the corresponding settings.

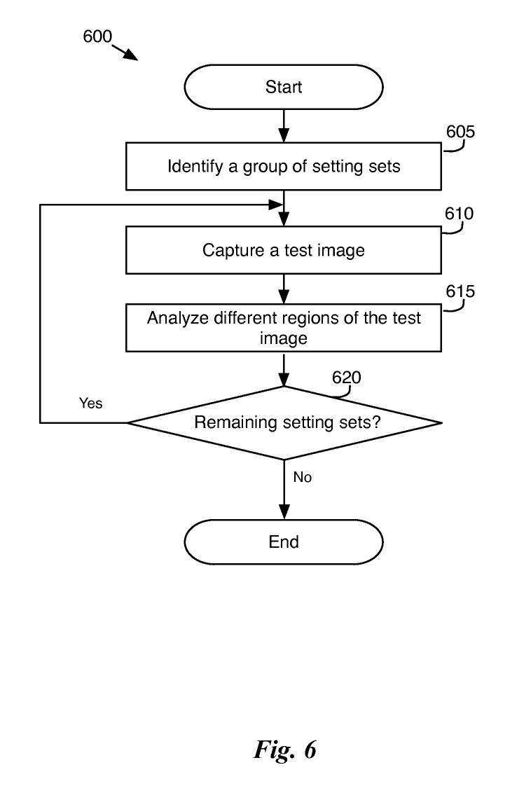

FIG. 6 conceptually illustrates a process for calibrating settings on a camera using a series of test images. The process 600 identifies (at 605) a group of setting sets on the camera. The setting sets may be a combination of several different settings, (i.e., aperture, ISO, focal length, etc.) or a single setting. For example, in some embodiments the process sets the focal distance of the lens to identify an optimal focus distance setting for a camera.

The process 600 then captures (at 610) a test image of a particular target using the apparatus described above with reference to FIG. 3. The process 600 then analyzes (at 615) different regions of the test image. In some embodiments, analyzing the different regions of the test image entails assigning a score to the different regions of the test image. In some embodiments, the scores for the different regions are compiled into a single score for the image.

As described above, in some embodiments, the center region of the image captures multiple targets at different distances, which is then reflected to other regions of the test image. Analyzing each region of the test image in these embodiments may further include evaluating each target within each region in order to determine the properties of each region of the test image for multiple distances at a particular setting. Evaluating multiple targets in each region allows for the calibration at multiple distances at the same time. For example, the center region may capture two buildings, at 100 m and 120 m respectively. The process 600 would then evaluate the properties of each of the buildings at the center of the image, as well as at each corner of the image. In some embodiments, the score for each region would depend on a combination of the scores for each target within the region.

Once the different regions of the image have been analyzed, the process 600 determines (at 620) whether there are any remaining setting sets in the group of setting sets. When there are remaining setting sets, the process 600 returns to step 610 to capture another test image of the particular target. When the last setting set has been processed, the process 600 evaluates the scores of the test images for each setting set to identify an optimal setting set. Determining the optimal setting set may involve identifying the setting set that generates an image with the best-worst properties. In some embodiments, the process 600 identifies the image with the highest minimum score for the different regions.

Test images may be used for a variety of different purposes. For example, a test image may be used to calibrate a camera/lens combination to determine an optimal focus setting (e.g., a particular position on a lens's focus ring) at a particular focus distance. Many camera lenses will provide different focus settings (i.e., markings on the ring of the lens) that indicate the focus distance for the particular setting. However, the focus settings may not always be indicative of the actual optimal focus setting for the particular focus distance.

In some cases, a lens may be calibrated to optimize for the center of the image such that the focus settings provide the sharpest possible image at the center of the image. For example, if the lens is focused at a target at 6 meters using only the center of the lens, the center of the lens may be optimally sharp. However, it could be that the focus distance of the corners at that particular focus setting is only 5.5 meters. Thus, if the target is at 6 meters, a captured image may be sharp at the center, but slightly out of focus at the corners. Similarly, if the lens is focused at the corners, the corners may be sharp, but may leave the center slightly out of focus.

In other cases, a lens may be calibrated to optimize for sharpness across the image. For example, a focus setting on a lens may indicate a distance of 5 meters to yield an ideal center focus distance at 4.9 meters and an ideal corner focus distance of 5.1 meters. However, for most cases, both corners and center will be “sharp enough” at 5 meters, being a compromise between the two. However, even if the lens focus settings are calibrated to provide the best sharpness for the overall image, the lens focus settings may still not provide an optimal sharpness due to imperfections in the lens design and manufacturing.

In order to balance the sharpness at the center and the corners, the entire frame should be evaluated at the same time, optimizing focus over the entire frame. By evaluating the center and the corners of images captured with a lens, a user can identify an optimal focus setting that maintains an acceptable level of sharpness for the center and the corners of the image.

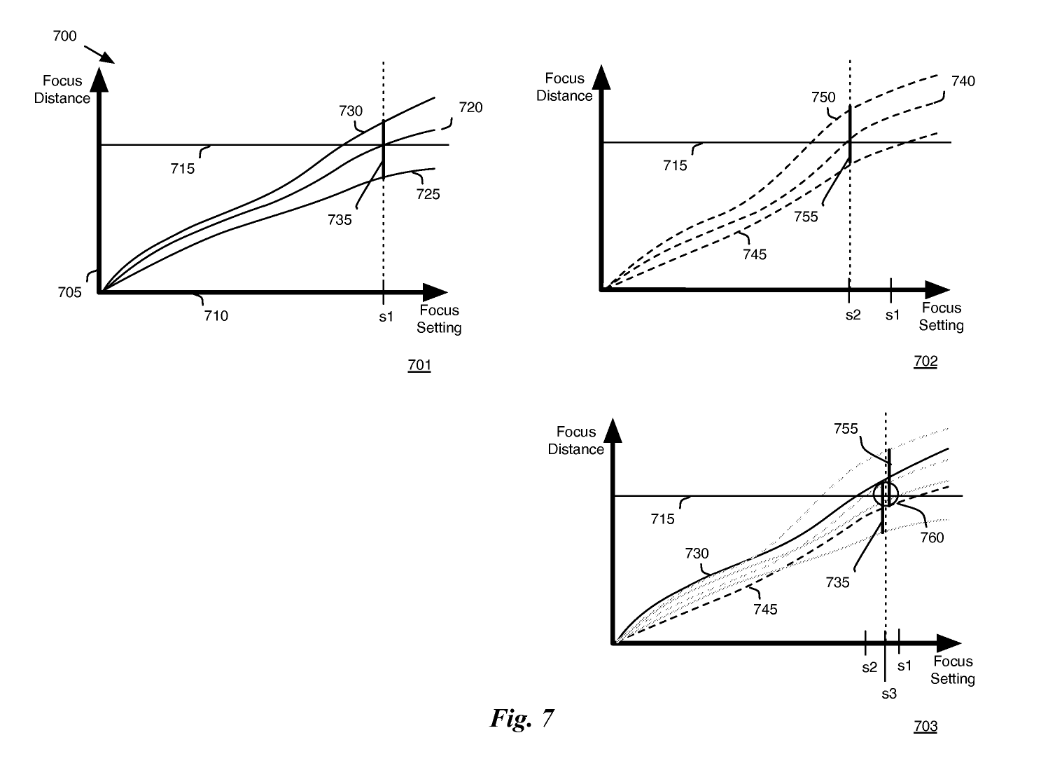

FIG. 7 illustrates an example of a chart used for calibrating a focusing distance for a camera based on sharpness in the different regions of a test image. More specifically, the figure includes three charts 701-703 that illustrate sharpness characteristics for different regions of the test image. In some embodiments, the calibration is performed by an image calibration program.

Each of the charts 701-703 illustrates a vertical axis 705 that represents a focus distance and a horizontal axis 710 that represents different focus settings (e.g., on a focus ring of a lens). The first chart 701 illustrates sharpness characteristics for the center of a test image. The first chart 701 includes a target focus distance 715 and graph lines 720, 725, and 730.

The target focus distance 715 represents the distance for which the focus is being calibrated. For example, in some applications of the invention, the test images may be used to calibrate a set of cameras to capture images at a particular distance.

Graph lines 720, 725, and 730 represent a range of the focus distance with a threshold sharpness at the center of the lens. The ideal focus graph line 720 represents the distance that is optimally in focus for each particular focus setting. The front focus graph line 725 represents a cutoff distance at which the area in front of the ideal distance maintains an acceptable level of sharpness. The back focus graph line 730 represents a similar cutoff distance at which the area behind the ideal distance is still sharp enough.

The first chart 701 also illustrates the optimal camera setting s1 for the target focus distance 715. Setting s1 indicates where the ideal focus graph line 720 intersects with the target focus distance 715. Setting s1 represents the focus setting at which the center of the lens will be the sharpest. The focus range 735 represents the range of distance with the acceptable level of sharpness.

The second chart 702 illustrates sharpness characteristics for the corners of a test image. The second chart 702 includes the target focus distance 715 and graph lines 740, 745, and 750. The ideal graph line 740, front focus graph line 745, and back focus graph line 750 correspond to the graph lines 720, 725, and 730 of the first chart 701, but represent the sharpness characteristics at the corners of a test image, rather than the center. As shown in the second chart 702, the sharpness characteristics of a lens are not necessarily linear and may change for different lens settings and for different distance settings. Like setting s1 for the center of the test image, setting s2 indicates where the ideal focus graph line 740 intersects with the target focus distance 715. Setting s2 represents the focus setting at which the corners of the test image will be the sharpest. The focus range 755 represents the range of distance with the acceptable level of sharpness.

The third chart 703 illustrates a combination of the charts from views 701 and 702. The third chart 703 includes the ideal graph line 720, front focus graph line 725, and back focus graph line 730 for the center of the test image from the first chart 701 as well as the ideal graph line 740, front focus graph line 745, and back focus graph line 750 for the corners of the test image from the second chart 702. The third chart also shows the ideal center and corner settings s1 and s2 respectively.

In addition, the third chart 703 illustrates that the optimal setting s3 to maximize the sharpness for the focus distance 715 lies between the back focus graph line 730 of the first chart 701 and the front focus graph line 745 of the second chart 702. As shown, the overlapping area 760 of focus ranges 735 and 755 of the first and second charts 701 and 702 is maximized at setting s3. The setting s3 keeps the greatest distance around the target focus distance 715 at an acceptable level of sharpness, optimizing sharpness over the entire frame. By evaluating both the center and the corners of a test image at once, a camera/lens can be calibrated to optimally focus across the entire frame of the image.

In addition to calibrating camera settings, a test image of some embodiments can be analyzed to identify mechanical problems in a camera/lens setup by comparing different regions of the test image. For example, when there are differences in sharpness between different corners of a test image, a user can determine that the alignment between the lens of the camera and the capture medium (e.g., film, digital sensors, etc.) needs to be adjusted.

### III. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

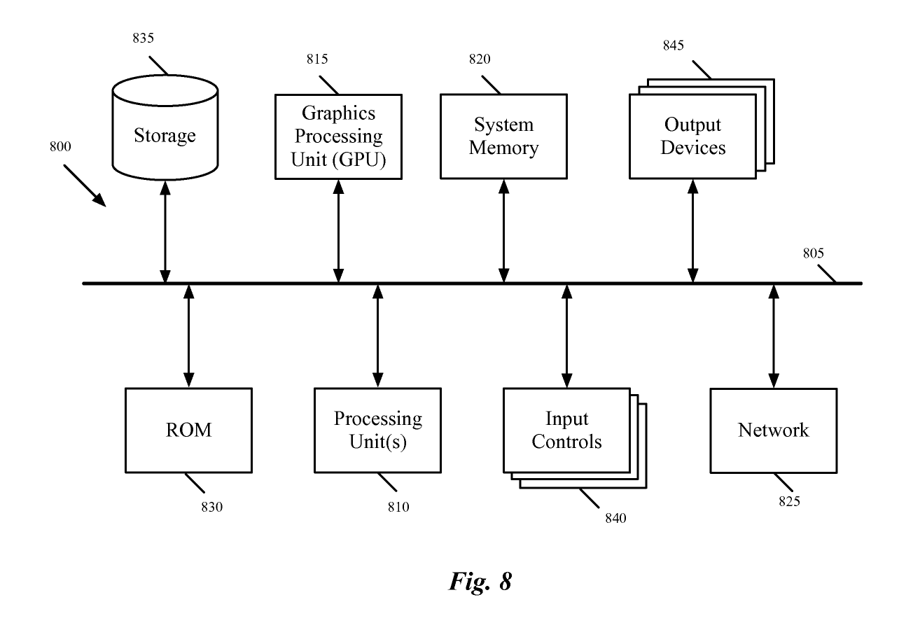

FIG. 8 conceptually illustrates an electronic system 800 with which some embodiments of the invention are implemented. The electronic system 800 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 800 includes a bus 805, processing unit(s) 810, a graphics processing unit (GPU) 815, a system memory 820, a network 825, a read-only memory 830, a permanent storage device 835, input devices 840, and output devices 845.

The bus 805 collectively represents all system, peripheral, and chipset buses that communicatively connect the numerous internal devices of the electronic system 800. For instance, the bus 805 communicatively connects the processing unit(s) 810 with the read-only memory 830, the GPU 815, the system memory 820, and the permanent storage device 835.

From these various memory units, the processing unit(s) 810 retrieves instructions to execute and data to process in order to execute the processes of the invention. The processing unit(s) may be a single processor or a multi-core processor in different embodiments. Some instructions are passed to and executed by the GPU 815. The GPU 815 can offload various computations or complement the image processing provided by the processing unit(s) 810.

The read-only-memory (ROM) 830 stores static data and instructions that are needed by the processing unit(s) 810 and other modules of the electronic system. The permanent storage device 835, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 835.

Other embodiments use a removable storage device (such as a floppy disk, flash memory device, etc., and its corresponding disk drive) as the permanent storage device. Like the permanent storage device 835, the system memory 820 is a read-and-write memory device. However, unlike storage device 835, the system memory 820 is a volatile read-and-write memory, such a random access memory. The system memory 820 stores some of the instructions and data that the processor needs at runtime. In some embodiments, the invention's processes are stored in the system memory 820, the permanent storage device 835, and/or the read-only memory 830. For example, the various memory units include instructions for processing multimedia clips in accordance with some embodiments. From these various memory units, the processing unit(s) 810 retrieves instructions to execute and data to process in order to execute the processes of some embodiments.

The bus 805 also connects to the input and output devices 840 and 845. The input devices 840 enable the user to communicate information and select commands to the electronic system. The input devices 840 include alphanumeric keyboards and pointing devices (also called “cursor control devices”), cameras (e.g., webcams), microphones or similar devices for receiving voice commands, etc. The output devices 845 display images generated by the electronic system or otherwise output data. The output devices 845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 8, bus 805 also couples electronic system 800 to a network 825 through a network adapter (not shown). In this manner, the computer can be a part of a network of computers (such as a local area network (“LAN”), a wide area network (“WAN”), or an Intranet, or a network of networks, such as the Internet. Any or all components of electronic system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (including FIG. 6) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. An apparatus for capturing a test image, the test image depicting a field of view (FOV) captured through a lens of a camera, the apparatus comprising:
a set of mirrors;
an adapter configured to mount to the camera and to position the set of mirrors such that a target captured in the center of the test image is reflected by each mirror of the set of mirrors in a corresponding region of the test image.

2. The apparatus of claim 1, wherein each mirror in the set of mirrors is a first surface mirror.

3. The apparatus of claim 1 further comprising an adjuster for adjusting the positioning of the set of mirrors in the adapter.

4. The apparatus of claim 3, wherein the adjuster adjusts the positioning of the set of mirrors based on the field of view captured through the lens of the camera.

5. The apparatus of claim 3, wherein the adjuster adjusts the positioning of the set of mirrors by simultaneously positioning each mirror of the set of mirrors at a particular angle relative to a center axis of the lens.

6. The apparatus of claim 1, wherein the set of mirrors comprises at least four mirrors and the adapter is configured to position the four mirrors at four corners of the field of view such that the target captured in the center of the test image is also captured at four corners of the test image.

7. The apparatus of claim 1, wherein each corresponding region of the test image is a corner of the test image.

8. The apparatus of claim 1, wherein the adapter is configured to fit over the lens of the camera.

9. A method for capturing a test image, the method comprising:
positioning a set of mirrors such that a target at the center of the image is reflected in each mirror of the set of mirrors;
capturing a test image.

10. The method of claim 9 further comprising evaluating the captured image to calibrate the camera.

11. The method of claim 9 further comprising:
capturing a plurality of test images with a corresponding plurality of camera setting sets; and
for each camera setting set of the plurality of camera setting sets, generating a score for the corresponding test image;
selecting a camera setting set of the plurality of camera setting sets based on the generated scores.

12. The method of claim 11, wherein generating a score for each corresponding test image comprises:
identifying first and second regions of the corresponding test image;
generating a first and a second score for the first and second regions respectively; and
generating a third score for the corresponding test image based on the first and second scores.

13. The method of claim 12, wherein the first region is at the center of the captured image and the second region is at an edge of the captured image.

14. The method of claim 9 further comprising:
identifying first and second regions of the test image, wherein the first and second regions are at different edges of the test image;
generating a first and a second score for the first and second regions respectively; and
based on the first and second scores, determining that a sensor is misaligned.

15. The method of claim 9, wherein positioning the set of mirrors comprises positioning each of the mirrors at a particular angle.

16. The method of claim 15, wherein positioning each of the mirrors at a particular angle comprises:
identifying a first angle relative to a plane of the camera that indicates the field of view;
based on the first angle, identifying a second angle for placement of the mirror; and
positioning the mirror at the second angle relative to the plane of the camera.

17. The method of claim 9, wherein positioning the set of mirrors comprises mounting an apparatus to a camera, the apparatus configured to position the set of mirrors in a field of view of the camera.

18. The method of claim 12, wherein the target is a first target at a first distance, wherein positioning the set of mirrors comprises capturing a second target at a second distance, wherein generating the first and second scores for the first and second regions comprises evaluating the first target and the second target in both the first and second regions.
